(19) United States
(12) Patent Application Publication
(10) Pub. No.: US 2026/0274386 A1
(43) Pub. Date: Sep. 17, 2026

(54) SEALED ORTHO-GRID LASER AND IMAGING DIRECTOR WITH A MULTISTAGE SEAL

(71) Applicant: United States of America, Department of the Navy, Arlington, VA (US)

(72) Inventor: Michael J. Pero, King George, VA (US)

(21) Appl. No.: 19/534,989

(22) Filed: Feb. 10, 2026

Related U.S. Application Data
(62) Division of application No. 18/446,118, filed on Aug. 8, 2023.
(60) Provisional application No. 63/441,209, filed on Jan. 26, 2023.

(51) Int. Cl. B63G 8/00; F16J 15/00; F16J 15/3204; G01S 7/481; G01S 17/89

(52) U.S. Cl. CPC B63G 8/001; F16J 15/002; F16J 15/3204; G01S 7/4813; G01S 17/89

(57) ABSTRACT

A gimbal and a pressure vessel with a multi-stage seal between the gimbal and the pressure vessel to protect optical equipment housed in the pressure vessel from the environment in a stowed position.

### CROSS REFERENCE TO RELATED APPLICATION

This application is a divisional of and claims the benefit of priority under 35 U.S.C. § 121 from U.S. patent application Ser. No. 18/446,118, filed on Aug. 8, 2023. U.S. patent application Ser. No. 18/446,118, in turn, claims the benefit of priority under 35 U.S.C. § 119(e) from U.S. Provisional Application No. 63/441,209, filed Jan. 26, 2023, and assigned Navy Case 211423. The entire contents of both of the foregoing applications are hereby incorporated by reference in their entirety.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to optical equipment. In particular, a storage system for protecting optical equipment in harsh environments.

### SUMMARY

A Sealed Ortho-Grid Laser and Imaging Director (SOLID) includes a yoke, a gimbal rotationally attached to the yoke, a pressure vessel slidably engaged with the yoke, and a seal. The SOLID is used to deploy optical equipment in harsh environments such as oceans. The SOLID includes a deployed position and a stowed position, and wherein the seal is engaged between the gimbal and the pressure vessel in the stowed position to protect the optical equipment from liquid or gas intrusion. The seal is a multi-stage seal which includes at least two seals. The SOLID may further include a lip that may be a formed as a rounded frustum which engages with a high pressure seal.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIGS. 1A-C show the Sealed Ortho-Grid Laser and Imaging Director (SOLID) in a stowed, standby, and engaged position;

FIG. 2 is a cut-away view of the SOLID in the standby position;

FIGS. 3A and 3B show one embodiment of the multi-stage seal;

FIG. 4 is another embodiment of the multi-stage seal;

FIG. 5 shows a cross-section of the first seal;

FIG. 6 is an exploded view of the pressure vessel;

FIG. 7 shows a detailed view of the ortho-grids and the iso-grid;

FIG. 8 shows a Finite Element Analysis (FEA) of the SOLID under pressure; and

FIG. 9 shows the SOLID in a subsea environment.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with an exemplary embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

The disclosure generally employs quantity units with the following abbreviations: length in meters (m) or ångströms (Å), mass in grams (g), time in seconds(s), angles in degrees (°), force in newtons (N), temperature in kelvins (K), energy in joules (J), and frequencies in gigahertz (GHz). Supplemental measures can be derived from these, such as density in grams-per-cubic-centimeters (g/cm³), moment of inertia in gram-square-centimeters (kg-m²) and the like.

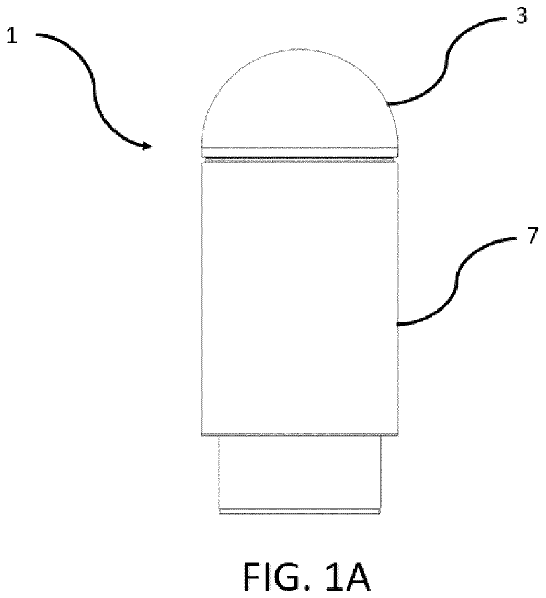

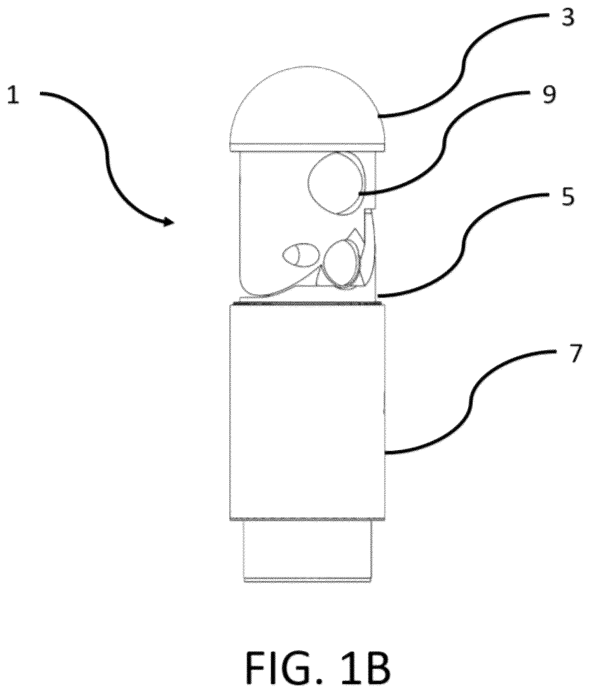

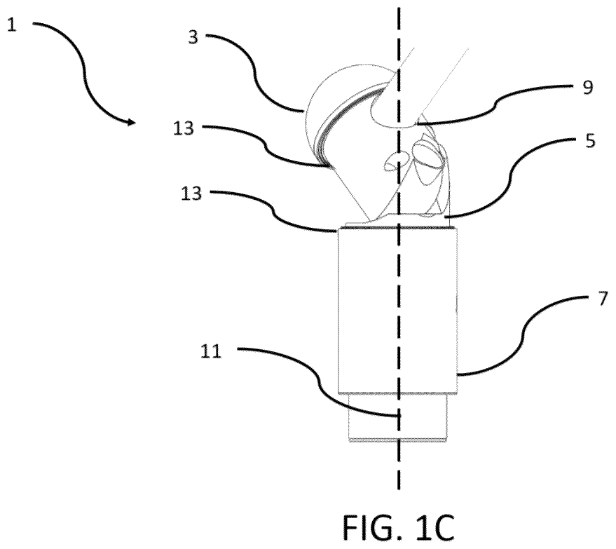

FIGS. 1A-C shows a Sealed Ortho-grid Laser and Imaging Director (SOLID) 1 in a variety of positions. The SOLID includes a beam director gimbal 3, a beam director yoke 5, and a pressure housing 7. In FIG. 1A, the SOLID 1 is shown in a stowed position. In FIG. 1B, the SOLID 1 is shown in a standby position. In FIG. 1C, the SOLID 1 is shown in an engagement position. The apparatus includes an actuator (not shown) which tilts the beam director gimbal 3, rotates the beam director yoke 5, and moves the apparatus between stowed, standby, and deployed positions.

As shown in FIG. 1C, the beam director gimbal 3, also called the gimbal, is rotationally attached to the beam director yoke 5. The gimbal 3 houses optical equipment 9 which may include lasers and/or cameras in an interior space. The gimbal maintains the optical equipment 9 level in unsteady environments such as on a vehicle or optical equipment carried by a person. The gimbal 3 maintains the optical equipment level by tilting the optical equipment with respect to axis 11 that extends through the pressure vessel 7. The beam director yoke 5, also called the yoke, is rotatably attached to the pressure vessel 7. The yoke 5 rotates the gimbal about axis 11. The pressure vessel 7 is slidably connected to the yoke 5 such that the pressure vessel 7 houses the yoke and the gimbal while SOLID is in a stowed position (as shown in FIG. 1B). Further, the slidable connection allows SOLID to move to a deployed position. The deployed position includes both the standby position (as shown in FIG. 1C) and the engagement position (as shown in FIG. 1). When the SOLID 1 is transitioned to the stowed position the multi-stage seal 13 is engaged to seal the optical equipment 9 from the environment.

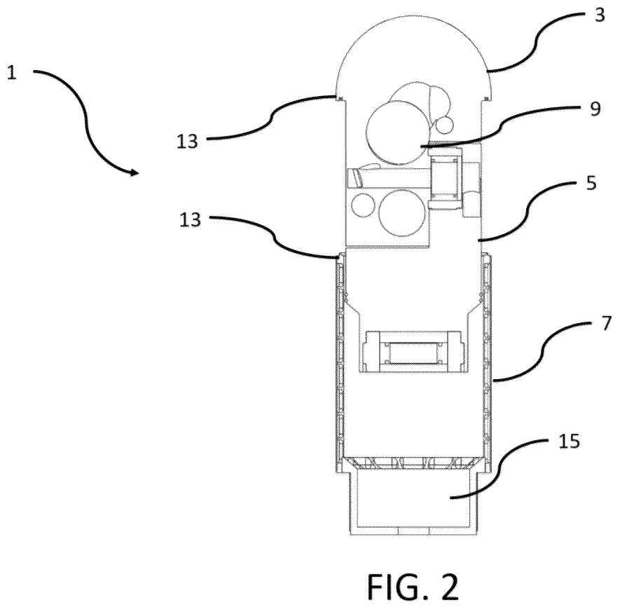

FIG. 2 is a cut-away view of the SOLID 1 in the standby position. The upper portion of the multi-stage seal 13 is arranged on the beam director gimbal 3 and the lower portion of the multi-stage seal 13 is arranged on the pressure vessel. Additionally, the pressure vessel 7 includes an interior space 15 which slidably receives the beam director gimbal 3 and the beam director yolk 5 when the SOLID 1 is placed in the stowed position shown in FIG. 1A.

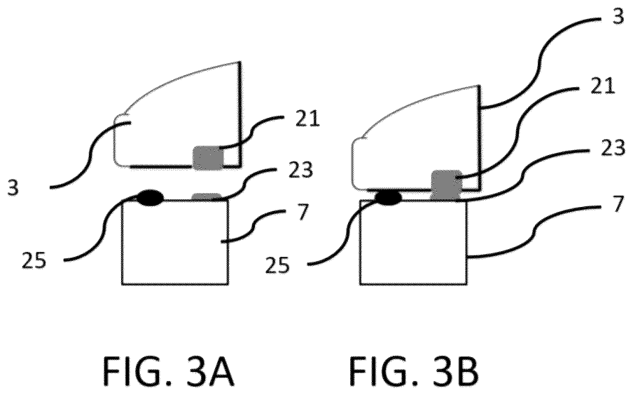

FIGS. 3A and 3B show one embodiment of the multi-stage seal 13. In this embodiment, a first seal which includes an upper seal 21 fixed to the beam director gimbal 3 and a lower seal 23 fixed to the pressure vessel 7. In other embodiments, the first seal may comprise only a single seal fixed to either the beam director gimbal 3 or the pressure vessel 7. The multi-stage seal further includes a second seal 25 which may be fixed to either the beam director gimbal 3 or the pressure vessel 7. In some embodiments, the first seal engages before the second seal which allows the liquid or gas to be self-purged from the interior space between the seals. In some embodiments, the first seal engages after the remaining seals. In further embodiments, the first seal is a higher pressure seal than the remaining seals. An exemplary material for the first seal is nylon plastic with Durometer D85 hardness (hard). Exemplary materials for the remaining seals are rubber seals with Durometer 70A hardness (medium hardness). The advantage of including a first seal with a higher hardness is that the SOLID can be used in a high pressure subsea environment that advantageously uses hydro-pressure to increase the self-sealing of the SOLID. The advantage of using a softer lower pressure-rated second and/or third seal is that it minimizes the required actuator strength. Further, this design advantageously allows seawater to self-purge liquid or gas to the environment between the first seal and the second and/or third seals due to the difference in hardness between the seals.

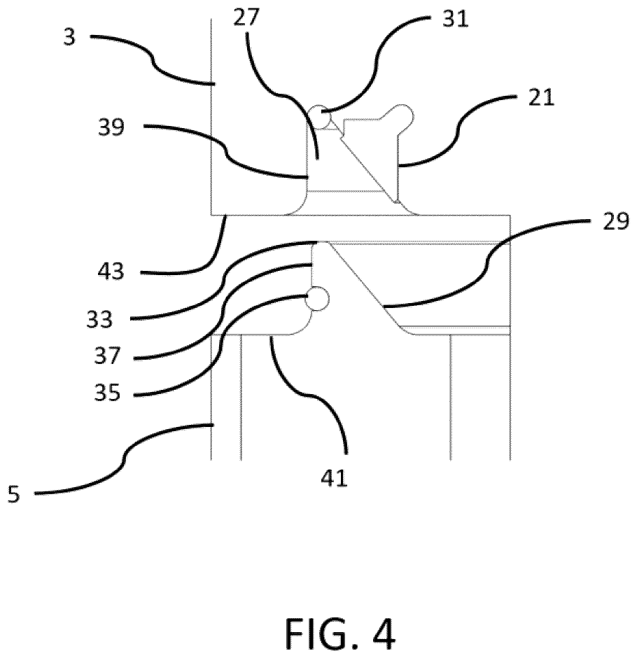

FIG. 4 is another embodiment of the multi-stage seal 13. In this embodiment, the beam director gimbal 3 includes a recess 27 which engages with a rim 29 that is formed in the pressure vessel 7. The shape of the recess 27 corresponds with the shape of the rim 29. In some embodiments, the shape is a rounded frustum. The multi-stage seal 13 further includes a second seal 31 fixed to the beam director gimbal 3. In some embodiments, the second seal 31 is arranged such that it engages with the peak 33 of the rim 29. In further embodiments, the multi-stage seal may further include a third seal 35 fixed to the pressure vessel 5. In some embodiments, the third seal is fixed to an outer surface 37 of the rim 29 such that it engages with an outer surface 39 of the recess 27. In other embodiments (not shown), the third seal is fixed to either surface 41 of the pressure vessel 5 or on the surface 43 of the beam director gimbal 3.

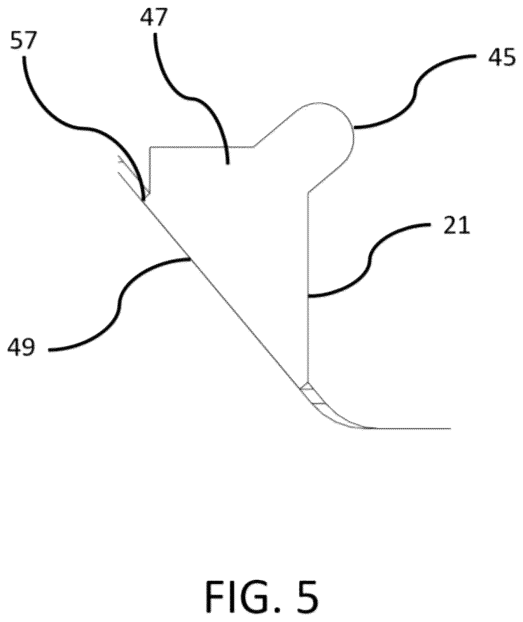

FIG. 5 shows a cross-section of the first seal 21. The first seal includes a fastening portion 45 and a crush volume 47. The fastening portion 45 engages with the beam director gimbal 3 to ensure that the first seal 21 remains fixed to the beam director gimbal 3. The crush volume 47 allows the seal to be compressed as the pressure on surface 49 increases. The crush volume 47 further allows the surface contact area 51 to decrease rather than cracking and/or deforming.

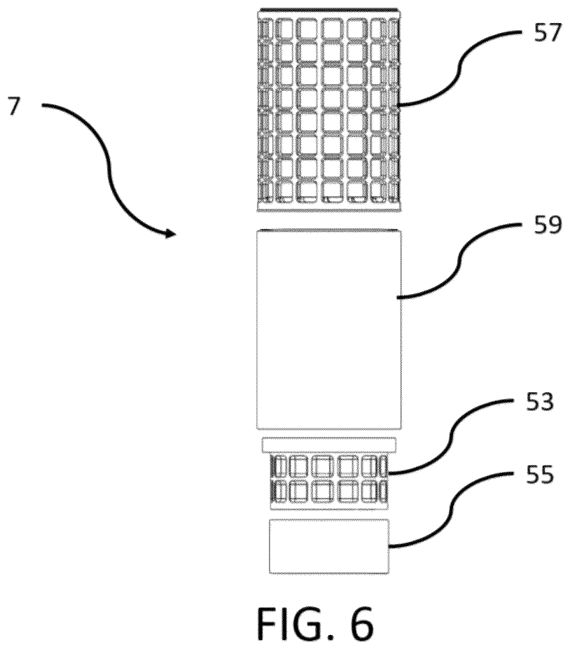

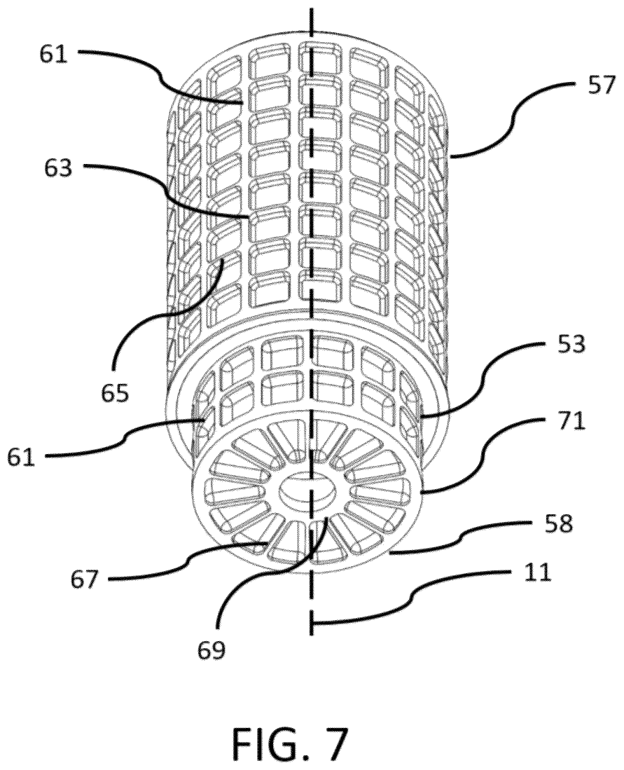

FIG. 6 is an exploded view of the pressure vessel 7. As seen in this view, the pressure vessel 7 includes an ortho-grid 53, an iso-grid 55 (shown in FIG. 7), a shroud 55, a second ortho-grid 57, and a second shroud 59. The shrouds 55, 59 are fixed to the corresponding ortho-grids and prevent the environmental elements from contacting the optical equipment housed inside the pressure vessel 7.

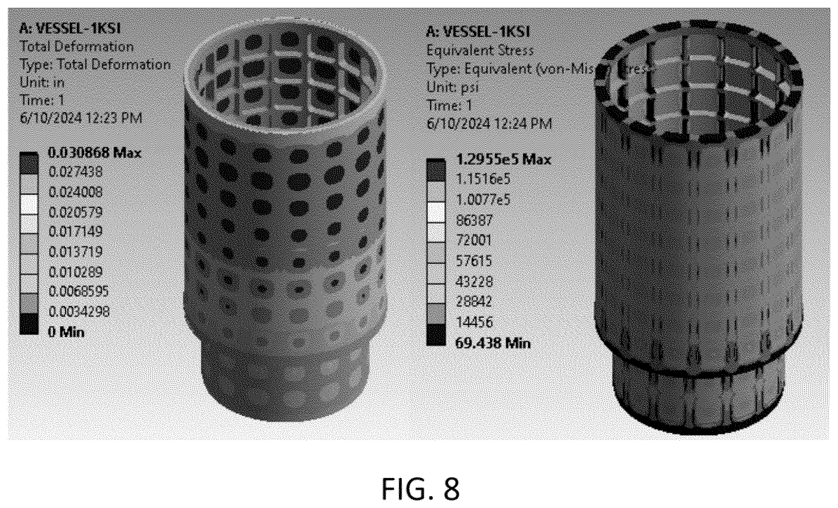

FIG. 7 shows a detailed view of the ortho-grids 53, 57 and the iso-grid 59. Each of the ortho-grids 53, 57 includes a plurality of axial columns 61, a plurality of nodes 63, and at least one cylindrical spar 65. In the ortho-grids 53, 57, the axial columns 61 are arranged circumferentially around axis 11 and the cylindrical spars 65 are arranged circumferentially around axis 11 and the axial columns 61 are fixed to the cylindrical spars 65 at a node 63. The iso-grid 59 includes a hub 69, radial spokes 67, and an iso-grid rim 71. The iso-grid 59 is fixed to ortho-grid 53 at cylindrical spar 65. The radial SPOKES 67 direct radial forces on the ortho-grid 53 from the iso-grid rim 71 to the hub 67. Each axial column 61 terminate at the iso-grid rim 71 proximate to a spoke 67. This configuration allows for both axial and non-axial forces to propagate from the ortho-grid to the iso-grid with minimum deformation of the pressure vessel (as shown in FIG. 8). This node-matched ortho/iso-grid design advantageously maximizes hydrodynamic pressure joint strength from a biaxial pressure load in the ortho-grid to a multiaxial pressure load in the iso-grid. This node-matched ortho/iso-grid design further allows the ortho-grid to be less robustly designed because the pressure forces are propagated into the strong iso-grid at the rim 71. As shown in FIG. 8, a Finite Element Analysis (FEA) shows less than 0.02″ maximum deflection under 1,000PSI load.

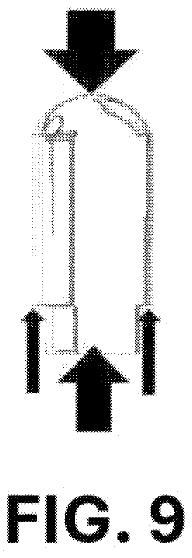

FIG. 9 shows the SOLID in a subsea environment. This design advantageously reduces the risk of actuator failure because in the subsea environment, the hard high pressure first seal uses the high water pressure (Identified by black arrows) to further engage the hard seal.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. An apparatus comprising:
a yoke;
a gimbal rotationally attached to the yoke;
a pressure vessel slidably engaged with the yoke; and
a seal;
wherein the apparatus includes a deployed position and a stowed position, and wherein the seal is engaged between the gimbal and the pressure vessel in the stowed position.

2. The apparatus according to claim 1, wherein the seal is a multistage seal, the multistage seal further comprising:
a first seal that isolates a second interior space from the first interior space; and
a second seal that seals a first interior space from a gas or fluid.

3. The apparatus according to claim 2, wherein the first seal is circumferentially arranged around an axis and the second seal is circumferentially arranged around both the second seal and the axis.

4. The apparatus according to claim 3, wherein the second seal is a softer than the first seal.

5. The apparatus according to claim 1, wherein the pressure vessel is configured to house optical equipment.

6. The apparatus according to claim 5, wherein the optical equipment comprises a laser emitter.

7. The apparatus according to claim 5, wherein the optical equipment comprises an imaging sensor.

8. The apparatus according to claim 1, further comprising an actuator configured to slide the pressure vessel relative to the yoke between the deployed and stowed positions.

9. The apparatus according to claim 1, wherein the gimbal is configured to provide at least one of azimuthal and elevation rotation to the pressure vessel.

10. The apparatus according to claim 1, wherein in the stowed position, the seal is configured to protect an interior of the pressure vessel from environmental elements.

11. The apparatus according to claim 10, wherein the environmental elements include at least one of dust, debris, liquid, and gas.

12. The apparatus according to claim 1, wherein in the stowed position, the apparatus forms a hermetically sealed enclosure.

13. The apparatus according to claim 1, wherein in the deployed position, the seal is disengaged from the gimbal.

14. The apparatus according to claim 1, wherein the pressure vessel comprises an ortho-grid and a shroud fixed thereto.

15. The apparatus according to claim 14, wherein the pressure vessel further comprises an iso-grid.

16. The apparatus according to claim 2, wherein the first seal is comprised of a hard plastic.

17. The apparatus according to claim 16, wherein the second seal is comprised of an elastomer.

18. A method of operating an optical director, the method comprising:
providing an apparatus in a deployed position, the apparatus comprising a yoke, a gimbal, and a pressure vessel containing optical equipment;
actuating the pressure vessel to slide from the deployed position to a stowed position; and
engaging a seal between the gimbal and the pressure vessel to create an environmentally sealed enclosure for the optical equipment.

19. The method of claim 18, further comprising the step of moving the apparatus from the stowed position to the deployed position by actuating the pressure vessel to disengage the seal from the gimbal.

20. The method of claim 18, further comprising the step of rotating the gimbal to aim the optical equipment when the apparatus is in the deployed position.
